(19) United States
(12) Patent Application Publication
(10) Pub. No.: US 2024/0095577 A1
(43) Pub. Date: Mar. 21, 2024

(54) MACHINE-DERIVED INSIGHTS FROM TIME SERIES DATA

(71) Applicant: INTERNATIONAL BUSINESS MACHINES CORPORATION, Armonk, NY (US)

(72) Inventors: Sumanta Mukherjee, Bangalore (IN); Bhanukiran Vinzamuri, Long Island City, NY (US); Vikas C. Raykar, Bangalore (IN); Arindam Jati, Bengaluru (IN); Nupur Aggarwal, Bangalore (IN)

(21) Appl. No.: 17/945,663

(22) Filed: Sep. 15, 2022

(51) Int. Cl. G06N 20/00

(52) U.S. Cl. CPC G06N 20/00

(57) ABSTRACT

Deriving insights from time series data can include receiving subject matter expert (SME) input characterizing one or more aspects of a time series. A model template that specifies one or more components of the time series can be generated by translating the SME input using a rule-based translator. A machine learning model based on the model template can be a multilayer neural network having one or more component definition layers, each configured to extract one of the one or more components from time series data input corresponding to an instantiation of the time series. With respect to a decision generated by the machine learning model based on the time series data input, a component-wise contribution of each of the one or more components to the decision can be determined. An output can be generated, the output including the component-wise contribution of at least one of the one or more components.

### TECHNICAL FIELD

This disclosure relates to computer processing of time series data, and more particularly, to automatically generating machine learning models capable of processing time series data and deriving insights therefrom.

### BACKGROUND

A time series is a sequence of quantitative values or observations taken at discrete times (e.g., fixed intervals) or continuously over a span of time. As a type of stochastic process, a time series is often modeled as a sequence of random variables. Examples include signals generated by a heat sensor during a chemical process, daily stock prices traded on the New York Stock Exchange, and seasonal rainfall in the city of London. A time series can explicitly encode the notion of causality of a process. Temporal resolution of time series data can enable effective data mining of the causal structure of a process. Tasks involving time series data include forecasting, anomaly detection, and classification, for example.

Analysis of a time series can be based on the statistical relatedness of the time series data. Statistical relatedness can be determined using autoregressive, or correlational, metrics to measure whether a time series value at one point in time is likely related to a value at another point in time, and if so to what extent, or are the data completely random. An alternative approach to time series analysis determines the attributes of a time series by decomposing the time series into the frequency spectrum. Time series analysis has many applications and, in one form or another, is used in virtually all areas of applied science, engineering, and economics.

### SUMMARY

In one or more embodiments, a method for deriving insights from time series data can include receiving subject matter expert (SME) input, wherein the SME input characterizes one or more aspects of a time series. The method can include generating a model template by translating the SME input using a rule-based translator, wherein the model template specifies one or more components of the time series. The method can include generating a machine learning model configured based on the model template. The machine learning model can be configured as a multilayer neural network having one or more component definition layers. Each component definition layer can be configured to extract one of the one or more components from time series data input corresponding to an instantiation of the time series. The method can include determining, with respect to a decision generated by the machine learning model based on time series data input, a component-wise contribution of each of the one or more components to the decision. The method can include outputting the component-wise contribution of at least one of the one or more components.

In one or more embodiments, a system for deriving insights from time series data includes one or more processors configured to initiate operations. The operations can include receiving subject SME input, wherein the SME input characterizes one or more aspects of a time series. The operations can include generating a model template by translating the SME input using a rule-based translator, wherein the model template specifies one or more components of the time series. The operations can include generating a machine learning model configured based on the model template. The machine learning model can be configured as a multilayer neural network having one or more component definition layers. Each component definition layer can be configured to extract one of the one or more components from time series data input corresponding to an instantiation of the time series. The operations can include determining, with respect to a decision generated by the machine learning model based on time series data input, a component-wise contribution of each of the one or more components to the decision. The operations can include outputting the component-wise contribution of at least one of the one or more components.

In one or more embodiments, a computer program product includes one or more computer readable storage media having instructions stored thereon. The instructions are executable by a processor to initiate operations. The operations can include receiving subject SME input, wherein the SME input characterizes one or more aspects of a time series. The operations can include generating a model template by translating the SME input using a rule-based translator, wherein the model template specifies one or more components of the time series. The operations can include generating a machine learning model configured based on the model template. The machine learning model can be configured as a multilayer neural network having one or more component definition layers. Each component definition layer can be configured to extract one of the one or more components from time series data input corresponding to an instantiation of the time series. The operations can include determining, with respect to a decision generated by the machine learning model based on time series data input, a component-wise contribution of each of the one or more components to the decision. The operations can include outputting the component-wise contribution of at least one of the one or more components.

This Summary section is provided merely to introduce certain concepts and not to identify any key or essential features of the claimed subject matter. Other features of the inventive arrangements will be apparent from the accompanying drawings and from the following detailed description.

### BRIEF DESCRIPTION OF THE DRAWINGS

The inventive arrangements are illustrated by way of example in the accompanying drawings. The drawings, however, should not be construed to be limiting of the inventive arrangements to only the particular implementations shown. Various aspects and advantages will become apparent upon review of the following detailed description and upon reference to the drawings.

FIG. 1 illustrates an example system for deriving insights from time series data.

FIG. 2 illustrates an example method of using the system of FIG. 1.

FIG. 3 illustrates certain operative aspects of the system of FIG. 1

FIGS. 4A and 4B illustrate certain other operative aspects of the system of FIG. 1

FIG. 5 illustrates an example prototype of a model template generated with the system of FIG. 1.

FIGS. 6A-6C illustrate example modeling strategies implemented by the system of FIG. 1.

FIG. 7 illustrates an example computing environment for implementing aspects of the system of FIG. 1.

### DETAILED DESCRIPTION

While the disclosure concludes with claims defining novel features, it is believed that the various features described within this disclosure will be better understood from a consideration of the description in conjunction with the drawings. The process(es), machine(s), manufacture(s) and any variations thereof described herein are provided for purposes of illustration. Specific structural and functional details described within this disclosure are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to computer processing of time series data, and more particularly, to using computer-implemented machine learning to derive guided insights into time series data. A time series can be composed into distinct components. If the time series has constant variance, the time series can be modeled as a summation of the components. If the time series' variance changes over time, the time series can be modeled as a product of the components. A time series component can span the entire time series or distinct portions. Many time series models are structured, for example, using four components—trend, cyclicality, seasonality, and randomness.

A time series comprising decomposable components can be modeled as a data generating process. For example, the autoregressive moving average (ARMA) process is structured as a combination of an autoregressive (AR) component and a moving average (MA) component. The AR component is derived by regressing a variable on its own lagged (past) values. The MA component models the difference between model-predicted values and actual values as a linear combination of contemporaneous and past errors. The autoregressive integrated moving average (ARIMA) process adds differencing to the ARMA process. Differencing can be used to impose stationarity on an otherwise non-stationary process. Models such as generalized autoregressive conditional heteroskedasticity (GARCH) are especially designed for estimating changes in the variance over time (heteroskedasticity) of time series data. An exponential smoothing of moving averages can be used to weight the time series data with exponentially declining weights. Various other structures can be used to model processes by which time series data is generated.

One notion of statistical analysis, generally, is causal inference. Causal inference over time series data, specifically, concerns the question of whether some event or phenomenon causes an observable change in values of the time series data. For example, do aggregate daily stock prices cause fluctuation in trading volume? For example, do Pacific Ocean surface temperatures affect the volume of sardine catches? Various concepts of time series causality have been proposed, Granger causality being one of the first. Causality has applicability with respect to autoregressive and spectral representations of time series. Causality assumes that current data are not affected by future, as-yet generated data and can be imposed as a structural constraint on a time series.

Often, knowledge that could reveal an appropriate structure for modeling a time series is known only to a subject matter expert (SME). For example, a cardiologist may know that normally a time series representation of a patient's ECG will exhibit a P-wave, QRS-complex, and T-wave that occur in a definite sequence. An economist, for example, may know that a certain exogenous shock (e.g., oil supply disruption) is likely followed by a cyclical downturn over time in a time series of country's gross domestic product (GDP). SMF knowledge can be structural, as for example, the knowledge that the P-wave, ORS-complex, and T-wave occur in sequence and that the QRS wave is sharper compared to both the P and the T-waves. SME knowledge can also be behavioral, as for example, the knowledge that a discount of a product's price likely precedes an increase in sales of the product, or that a change in the Hurst exponent (measuring a time series' long-term “memory”) precedes a change in an asset's market return.

Notwithstanding the insights provided by SME knowledge, it is often difficult to integrate that knowledge into existing time series models. One difficulty that arises pertains to the problem of model selection. SME knowledge, though insightful, typically does not resolve the choice of a particular model nor suggest which components in what arrangement should be used to construct the model. Moreover, one model may not sufficiently encode all model assumptions stemming from the SME knowledge.

Additionally, SME knowledge is often likely to be qualitative in nature. SME knowledge, accordingly, may provide little if any insight into which of multiple components contribute the most to the time series model's decision (e.g., regression, classification, anomaly detection).

The systems, methods, and computer program products disclosed herein are capable of creating an automated framework for deriving insights from time series data utilizing domain knowledge. As defined herein, “insight” means the identification of one or more components of a time series model and the determination of each identified component's contribution to the decision or outcome of the time series model. The decision can be a forecast, classification, anomaly detection, or other model decision generated based on the specific values of a given time series. Relatedly, “component” as defined herein means a factor that affects the observed values of a time series. Thus, a component can correspond to an event or physical phenomenon. A time series is characterized by the components of the time series. For example, an ECG output is a time series characterized by three components— P-wave, QRS-complex, and T-wave—corresponding to physical phenomena associated with a patient's cardiac activity. A time series of a country's GDP, for example, is typically characterized by a longer-term trend component associated with economic growth and cyclical components associated with business cycles. A company's sales may also show a trend component as well as components associated with peaks and troughs in sales that occur seasonally or in response to specific events such as flash sales.

An aspect of the use of domain knowledge in accordance with the inventive arrangements disclosed herein, is the automated creation of a knowledge-based model template generated based on SME input. In certain arrangements, the model template is generated through a computer-implemented translation of SME input. The model template can specify a modeling strategy for modeling a given time series. The model template, based on SME input, can specify the structural components (e.g., trend or cyclicality) of the time series. The model template can specify a causal structure, such as a predetermined event that causes a spike or fall in time-indexed values of the time series.

Accordingly, another aspect of the inventive arrangements is use of the model template to create a time series according to the template-defined components and component structure. In certain arrangements, the model template specifies a relative position of each of the components. Thus, in accordance with the inventive arrangements, a time series model can be automatically implemented with the components structured according to the template generated from the translation of the SME input. The structure can include, for example, the relative positioning of the components in a sequence. For example, in the context of anomaly detection with respect to ECG-generated time series, the model template can specify that a normal component structure is an ordered sequence in which a P-wave is followed by a QRS-complex, which in turn, is followed by a T-wave. The structure can include a causality constraint. For example, based on SME input, the template can specify with respect to a time series of a company's sales that a promotional event precedes a surge in sales.

Another aspect of the inventive arrangements is the generation of a machine learning model of the time series, the generation based the model template. The machine learning model in certain arrangements can be a deep learning model. For example, the machine learning model can be a recurrent neural network, a convolutional neural network, a generalized additive model (GAM), or other deep learning model.

Another aspect of the inventive arrangements is a computer-generated estimation of the contribution of each component to the time series model decision (e.g., forecast, classification, anomaly detection). For example, in the context of ECG anomaly detection, a system implemented according to an inventive arrangement can be configured to determine which signal component of the time series— P-wave, QRS-complex, or T-wave—most likely contributes to detecting an anomaly. The arrangement thus can provide an interpretable classifier that can identify which component is likely to lead to a correct diagnosis.

In the context of forecasting, for example, the system can be configured to generate a forecast of economic activity (e.g., GDP) using a time series model whose components are decomposed into structural events that include cyclical peaks, seasonal variations, and recent output surges in response to fiscal stimulus. Accordingly, the arrangement can provide an interpretable forecaster. The interpretable forecaster can identify spectral components (e.g., trend, cyclicality) or regression components that produce a time-specific forecast.

In yet other arrangements, different models can be generated based different machine-generated templates based on SME inputs. A system, according to certain novel arrangements, can generate a contrastive assessment of the respective models. The contrastive assessment can indicate the respective predictive accuracies of each of the different models, as well as which components of each model were most significant in generating each of the model's decision with respect to a predetermined set of time series data.

Further aspects of the inventive aspects described within this disclosure are described in greater detail with reference to the figures below. For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

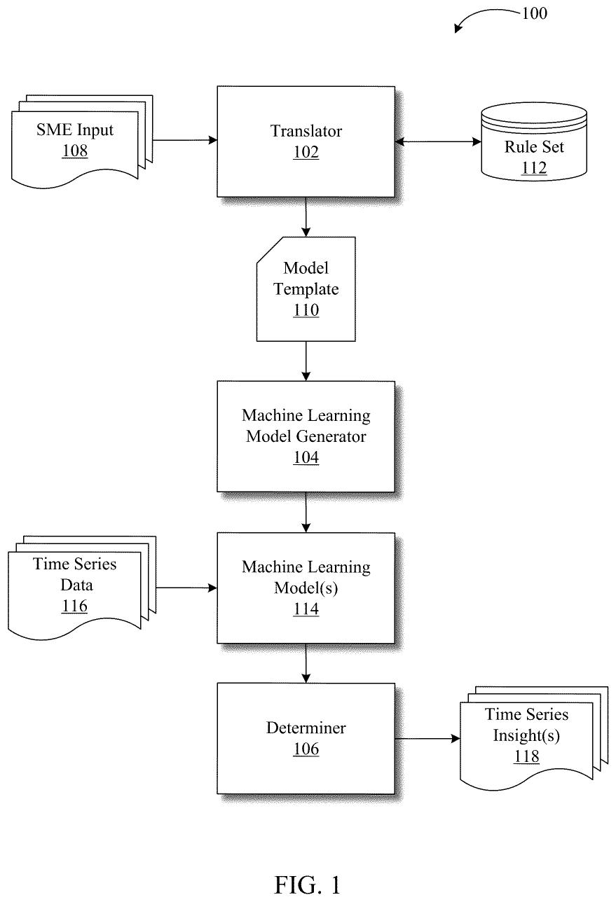

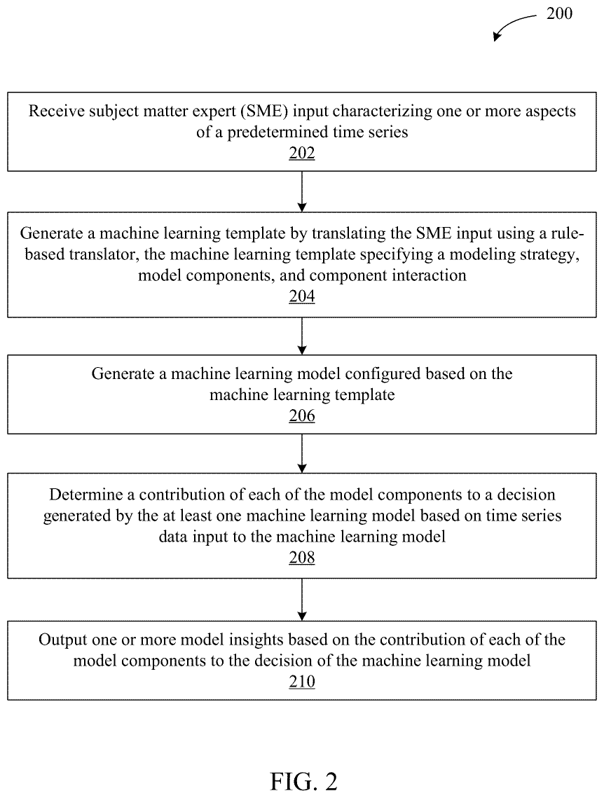

Referring initially to FIGS. 1 and 2, an example system for deriving insights from time series data (system) 100, and a methodology 200 of implementing certain operative aspects of the disclosure are illustrated. Operatively, system 100 is capable of creating a template based on certain received knowledge-based SME input. The SME input can specify components that characterize a time series. Using the template, system 100 is capable of generating one or more machine learning models that are built based on the components specified by the SME input. Each machine learning model generated by system 100 thus provides a model representation of a time series that incorporates the components specified. In certain arrangements, the template also can include a user-specified modeling strategy. The SME input thus can specify a strategy for modeling the time series as well as the components of the time series. The components specify the structure of the model. The modeling strategy specifies how the model is represented—that is, the architecture of the machine learning model. The modeling strategy specified by the template can specify a known architecture (e.g., recurrent neural network, 1-D convolutional neural network) or a user-customized architecture. Accordingly, in some arrangements, one or more keywords indicating a modeling strategy can map to a predetermined machine learning architecture. In other arrangements, one or more keywords can map to a specification indicating certain attributes of a user-customized machine learning architecture (e.g., number of hidden layers, activation functions, gradient decent criterion function, stopping criterion).

System 100 is not only capable of generating the machine learning model(s) based on the SME input-specified components but is also capable of deriving insights into the time series based on time series data input to the machine learning model(s) once generated. The time series data input is data corresponding to an instantiation of a time series. For example, the readout of a patient's ECG corresponds to an instantiation of a time series comprising a P-wave component, QRS-complex component, and T-wave component. Executing the machine learning model(s) on a given set of time series data, system 100 can determine the contribution that each component makes to the machine learning model's decision (e.g., forecast, anomaly detection, classification). System 100, in certain arrangements, can determine on a predetermined quantitative scale (e.g., between 0 and 1) which components make a contribution greater than a predetermined threshold (e.g., 0.5) and which that do not. In the context of an ECG readout, for example, knowing which component most likely indicates a cardiac anomaly can assist a healthcare professional in more quickly making a diagnosis. In some instances, for example, reconfiguring a machine learning model by retaining components determined to be significant, and eliminating those that are not, may improve the model's predictive accuracy and is likely to lessen the processing burden on a computer system's resources.

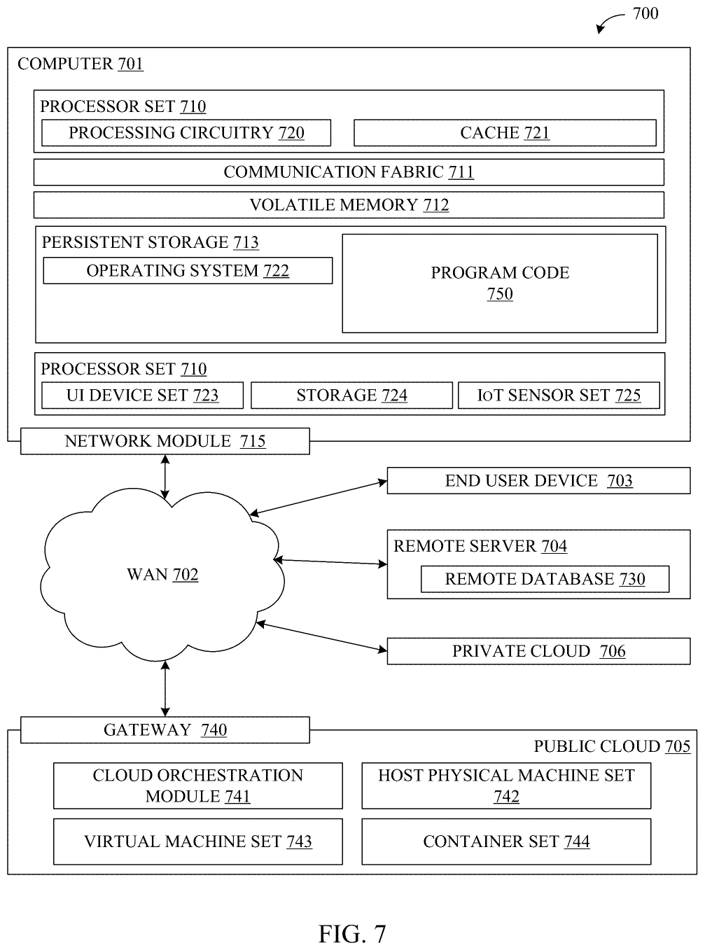

Referring still to FIGS. 1 and 2, in certain arrangements, system 100 can include translator 102, machine learning model generator 104, and determiner 106. Translator 102, machine learning model generator 104, and determiner 106 can be implemented in hardware (e.g., dedicated hardwired circuitry), software (e.g., program code executed by one or more processors), or a combination thereof. For example, system 100 in certain embodiments may be implemented in computer-readable program instructions loaded onto a computer, such as computer 701 of computing environment 700 (FIG. 7).

At block 202, system 100 can receive SME input 108 from a user. SME input 108, in some arrangements, can be received as natural language input to a computer via a user interface, illustrated by various elements of UI device set 723 (FIG. 7). Natural language input can be conveyed via text or voice, which optionally can be converted to text. System 100 can be configured to perform natural language processing on the natural language input. SME input 108 can be extracted from the natural language input by system 100. SME input 108 can characterize aspects of a predetermined time series. For example, SME input 108 can characterize components (e.g., P-wave, QRS-complex, T-wave) of a time series of electrode-generated signals recorded by an ECG, or a time series of interest rates represented by computer-encoded data retrieved online from a central bank (e.g., Federal Reserve). In some arrangements, in performing natural language processing, system 100 parses a natural language input (e.g., implementing a parser such as the Berkeley Neural Parser) to identify parts of speech of natural language input and to extract therefrom SME input 108 comprising certain keywords. As defined herein, “extracting” means creating data structures specifying the keywords such that the keywords exist independently and distinctly apart from the natural language input. For example, the keywords can be encoded as a vector, matrix, or higher-dimension tensor.

At block 204, translator 102 of system 100 is capable of generating model template 110 by translating SME input 108. In certain arrangements, translator 102 is configured to translate the SME input using a rule-based translation. With the rule-based translation, translator 102 identifies one or more predefined keywords (e.g., domain-specific keywords) or phrases contained in SME input 108. Rule set 112 maps each of a complete set of predefined keywords and phrases to specific components of a time series. For example, translator 102 can map domain-specific keywords to model-specific keywords (e.g., trend, wave, cycle) corresponding to components that characterize the time series. For example, a component can characterize the structure of the time series (e.g., trend, cyclicality, seasonality). A component, for example, can characterize causality (e.g., a causal structure such flash sales that invoke a spike in units sold). Translator 102, based on specific keywords and phrases identified in SME input 108, creates model template 110. Model template 110 thus can include the specific components of a time series that rule set 112 maps to the keywords and/or phrases of SME input 108.

Thus, translation at block 204 of SME input 108 characterizing the time series can provide structural information for constructing a model representation of the time series. For example, structural information can indicate whether the model should be constructed as a stationary time series, whether the model variance is constant, whether the model exhibits seasonality, and if so to what extent and with what periodicity. SME input 108, for example, can indicate a causal structure. That is, whether certain phenomena or events tracked by the time series precede or follow others. By translating SME input 108, translator 102 generates model template 110 to incorporate the structural information and, as applicable, any causal structure. In generating a machine learning model from template 110, as described below, the structural information can specify, for example, a relative ordering of temporal patches (e.g., window wise, predefined units for automatic discovery mode, threshold values). Likewise, causal structure can be used to identify functional dependencies of a machine learning model (e.g., an explicit causal structure can provide a sparse model). These and other types of structure and causality characterizing a time series are collectively referred to as components of the time series.

At block 206, machine learning model generator 104 is capable of generating machine learning model 114 based on the components extracted from SME input 108. Machine learning model 114 is generated in accordance with template 110, which incorporates the components extracted from SME input 108. Machine learning model 114 is a model representation of a time series generated in accordance with model template 110 and is thus built based on SME input 108. Machine learning model 114 models the time series as characterized by the components extracted from SME input 108 and translated into model template 110. Thus, machine learning model 114, as generated at block 206 by machine learning model generator 104, is built based of components extracted from SME input 108 by translator 102 at block 204.

In certain arrangements, machine learning model 114 is configured based on model template 110 as a neural network having one or more component definition layers. Each of the one or more component definition layers can be uniquely configured to extract one of the one or more components from the time series data input. In some arrangements, the component definition layer(s) can be stored in a library and retrieved therefrom based on translator 102 matching a keyword with a stored component definition layer.

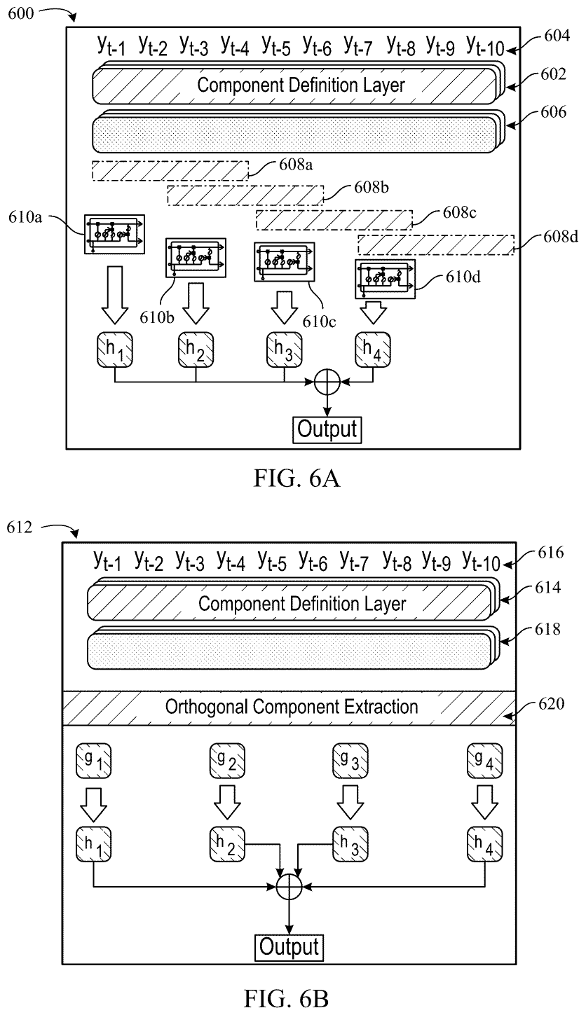

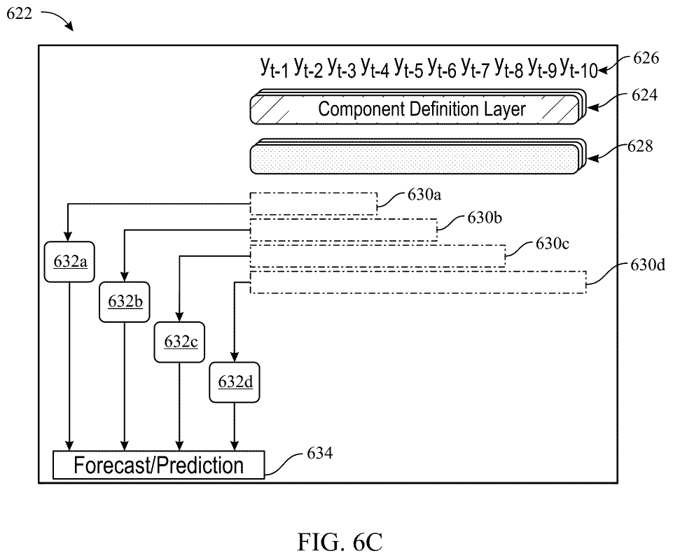

In certain arrangements, machine learning model 114 is a deep learning neural network comprising an input layer, an output layer, and one or more hidden layers as illustrated in the examples of FIGS. 6A-6C. In some arrangements, machine learning model 114 is generated by machine learning model generator 104 as a recurrent neural network. As a recurrent neural network, machine learning model 114 is specialized for processing a sequence of values (e.g., time-indexed values of a time series) and includes one or more layers of recurrent neurons that, at each time step, receive a current input (e.g., vector) along with a prior layer's output. In other arrangements, machine learning model 114 is generated by machine learning model generator 104 as a convolutional neural network (e.g., a 1-D CNN) characterized by parameter sharing.

In still other arrangements, machine learning model 114 can be generated at block 206 by machine learning model generator 104 to have other different or specialized characteristics. As described below, model template 110 in accordance with certain arrangements includes a modeling strategy field that specifies the specific characteristics. For example, as generated by machine learning model generator 104, machine learning model 114 can comprise a wavelet transformer. The wavelet transform can identify frequency components of a time series. If machine learning model 114 is configured as a forecasting model, for example, the frequency components can be used to generate predictions.

Once generated at block 206, machine learning model 114 is capable of rendering a decision in response to the inputting of time series data 116. The decision can be a forecast of a value, a classification of the time series from which time series data 116 is derived (e.g., classifying the time series as an anomaly or not), or other decision depending on the specific task that machine learning model 114 is configured by model template 110 to perform.

At block 208, determiner 106 derives one or more time series insights 118 from the output of machine learning model 114 based on time series data 116. Time series insight(s) 118 can include a component-wise contribution that each of the one or more components of the time series makes to the model's decision. Accordingly, system 100 not only constructs machine learning model 114 based on components extracted from SME input, but also is capable of determining how much each of the components contributes to the decision of machine learning model 114. System 100, at block 210, outputs time series insight(s) 118 to the user.

Determiner 106, in certain arrangements, implements a backpropagation algorithm to determine each component's effect on the decision of machine learning model 114. Backpropagation is an efficient mechanism for calculating derivatives of a single target quantity (e.g., pattern classification error) with respect to a large set of input quantities (e.g., parameters) in any large system made up of elementary subsystems or calculations that are represented by known, differentiable functions. In implementing a backpropagation algorithm, determiner 106 computes a gradient with respect to the parameters of machine learning model 114 by applying the chain rule theorem to an ordered set of partial derivatives. The values of the partial derivatives indicate the magnitudes of a unit change in each functional unit corresponding to a component of machine learning model 114. Determiner 106 uses the values to determine each component's effect on the decision (e.g., forecast, regression, classification, anomaly detection) of machine learning model 114.

In certain arrangements, determiner 106 is configured to implement the Gradient-weighted Class Activation Mapping (Grad-CAM) approach. Grad-CAM is applicable with respect to a wide variety of CNN models. Grad-CAM can use gradients of a target concept flowing into the final convolutional layer of a CNN to produce a coarse localization map, the map highlighting important regions, for example, of an image for predicting the concept.

The effect of a component on the decision of machine learning model 114 is itself a time series insight derived by determiner 106 from time series data 116 and is among the ways that system 100 is capable of evaluating the decision(s) made by machine learning model 114. In various arrangements, time series insight(s) 118 can include other, additional insights. Time series insight(s) 118 can provide, for example, an instance-based explanation of which data point or group of data points contribute to the decision of machine learning model 114. Time series insight(s) 118 can vary with the particular decision-related task of machine learning model 114. For example, if machine learning model 114 is configured for anomaly detection, time series insight(s) 118 derived by determiner 106 can indicate which component or components contribute significantly to the anomaly. Knowledge of the component likely contributing to the anomaly may guide a user toward discovery of the root cause of the anomaly. For example, in the context of classifying an ECG-generated time series as anomalous, knowing whether the P-wave, QRS-complex, or T-wave is the more likely component contributing to the anomaly may assist in individual diagnoses and may guide researchers in uncovering likely causes of the anomaly. Thus, as noted above, system 100 not only creates machine learning model 114 based on components specified by SME input 108 but also can evaluate the model by identifying which components contribute most significantly to machine learning model 114's decision (e.g., forecast, classification, anomaly detection).

Another example of insights derived by system 100 pertains to exogenous variables as well as component contributions. Because components of a time series can correspond to a specific event, if machine learning model 114 is configured for generating a forecast or prediction, for example, time series insight(s) 118 derived by determiner 106 can identify an exogenous variable that significantly contributes to the forecast or prediction. For example, in forecasting or predicting future GDP using machine learning model 114, determiner 106 can determine based on time series data the likely effect of an exogenous variable, such as an “oil shock” (disruption of supply). Similarly, if machine learning model 114 is configured to predict a company's sales, determiner 106 can identify a possible seasonal component that is likely to affect the sales, which in turn, can suggest an appropriate marketing strategy.

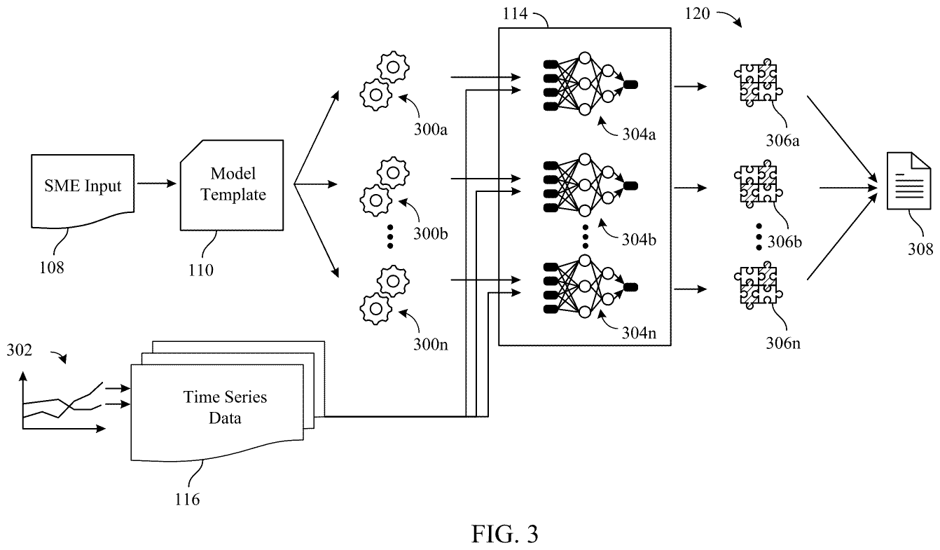

Referring additionally to FIG. 3, certain operative aspects of system 100 are schematically illustrated. Illustratively, model template 110—generated by translating SME input 108 extracted from natural language input—defines component configurations 300a, 300b, and 300n. Component configurations 300a, 300b, and 300n each correspond to a distinct component of time series 302, as well as any functional relations that a component has with respect to other components of time series 302. Time series 302, for example, is generated by one or more sensors (e.g., ECG electrodes) or collected from one or more sources (e.g., Federal Reserve-compiled interest rates). Time series data 116 is extracted from time series 302 and input to machine learning model 114. Machine learning model 114 includes component definition layers that extract component configurations 300a, 300b, and 300n. Processing 304a is performed by machine learning model 114 with respect to component configuration 300a. Similarly processing 304b and 304n are performed, respectively, with respect to component configurations 300b and 300n by machine learning model 114. System 100 outputs time series insight(s) 118, which illustratively include model insights 306a, 306b, and 306n. Model insights 306a, 306b, and 306n are generated respectively by processing 304a, 304b, and 304n performed by machine learning model 114 with respect to component configurations 300a, 300b, and 300n, as defined by model template 110.

Optionally, system 100 can compile model insights 306a, 306b, and 306n and convey them to the user as consolidated report 308. In other arrangements, system 100 optionally generates multiple machine learning models, each configured based on a different model template. System 100 can generate a contrastive explanation, included in consolidated report 308, that delineates differences between the machine learning models. Corresponding time series insights provided as part of the contrastive explanation can indicate, for example, which aspects of a time series each machine learning model emphasizes, which provides greater predictive accuracy, and/or other such time series insights.

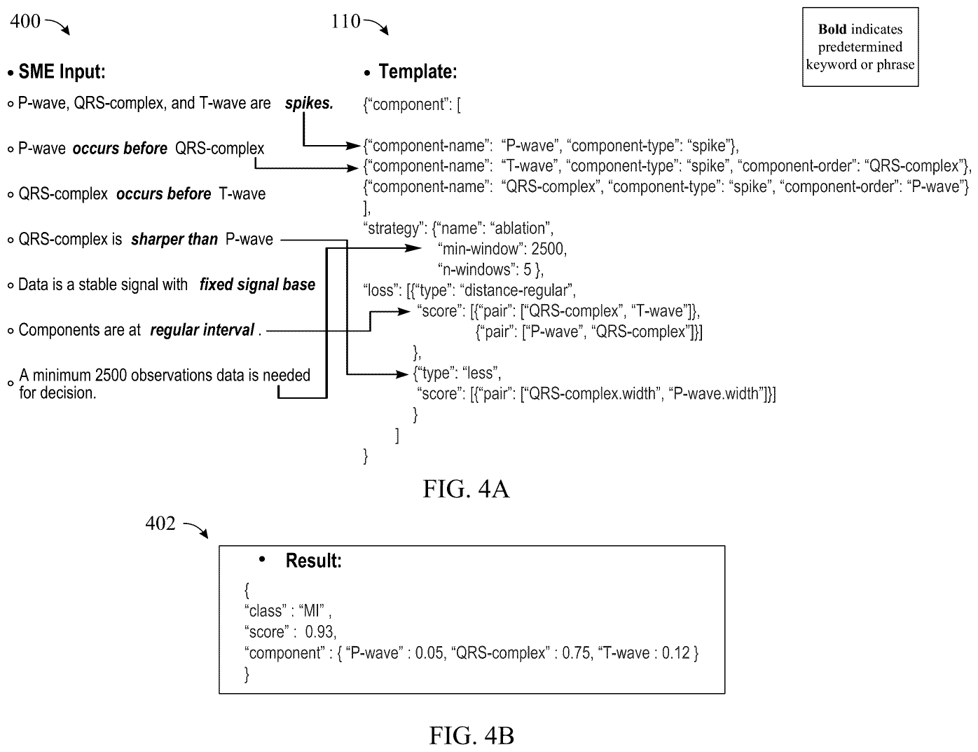

Referring additionally to FIGS. 4A and 4B, certain operative features of the translation performed at block 204 by translator 102 are illustrated in the specific context of an ECG time series. Illustratively, in FIG. 4A, translator 102 identifies domain-specific keywords (e.g., “spikes”) and phrases (“occurs before,” “sharper than,” “fixed signal base,” and “regular interval”) shown in bold within SME input 400. Certain domain-specific terms (e.g., “P-wave,” “QRS-complex,” “T-wave,” and “minimum 2500 observations”) also occur within SME input 400. Translator 102 translates SME input 400 into certain illustrative portions of template 110 expressed as processor-executable code, which can be used in generating a time series model (described below) whose components and structural arrangement correspond to SME input 400. Template 110, expressed as processor-executable code, is used by system 100 to build machine learning model 114. Constructed according to the components specified by template 110, machine learning model 114 models a time series comprising a P-wave, QRS-complex, and T-wave.

Illustratively, in FIGS. 4A and 4B, machine learning model 114 is configured for the task of anomaly detection based on classifying a time series generated by an ECG monitor used to detect a patient's cardiac activity. Inputting a specific set of times series data, as generated by the ECG, to machine learning model 114 illustratively generates result 402, shown in FIG. 4B. Machine learning model 114, based on the data input, assigns the time series to the class “MI,” indicating the anomaly myocardial infarction. The output “score” indicates a confidence level of the classification by machine learning model 114. The “component” output indicates that the QRS-complex makes a significantly greater contribution (0.75) to the decision (anomaly detected) of machine learning model 110 than that of either the P-wave or T-wave (0.05 and 0.12, respectively). Thus, FIGS. 4A and 4B, illustrate system 100's automated constructing of machine learning model 114 based on SME input 108 components (P-wave, QRS-complex, and T-wave) specified by template 110, and deriving insights from time series data by running machine learning model 114 on the data. FIGS. 4A and 4B further illustrate, system 100's evaluating the significance of the components to the decision of machine learning model 114. Thus, as noted above, another example of system 100's deriving insights from time series data is determining which among multiple components most likely determines a classification by machine learning model 114.

In accordance with various arrangements, template 110 is capable of specifying several distinct aspects of a model representation of a given time series. Template 110 can specify the model components of the time series model. The components of the time series model are distinct patterns. Components, as noted above, can include one defined over an entire time domain, such as trend and seasonality spanning an entire time-based window of the series. Others pertain to specific events occurring during a specified time slice, or limited portion, of a complete time series. An example, in the context of a time series tracking the sales of a product, is a flash sale that lasts for a limited duration (time slice) and corresponds to an increase in sales of the product. Template-specified components also can correspond to predefined metrics specifying constraints on a time series, such as autocorrelation, constant variance, linear trend, stationarity, and the like. As described below, each component (e.g., trend, temporal segment) can be stored in a separate representation channel of the time series model.

As noted above, template 110 can specify, based on SME input 108, a modeling strategy for generating a model representation of the given time series. In certain arrangements, the modeling strategy is a mandatory specification for template 110. System 100, accordingly, can be configured to prompt a user if SME input 108 does not include a modeling strategy. System 100 uses the modeling strategy to structure a base model. Depending on other SME input different versions of the time series model can be constructed by modifying the base structure. For example, the modeling strategy can be used by system 100 to partition the components of the time series model into temporal segments. Each partition can be separately modeled by modifying the structure of the base model. If the modeling strategy is mandatory, system 100 optionally can automatically specify a strategy if the user fails to do so. In some arrangements, ablation is a default modeling strategy.

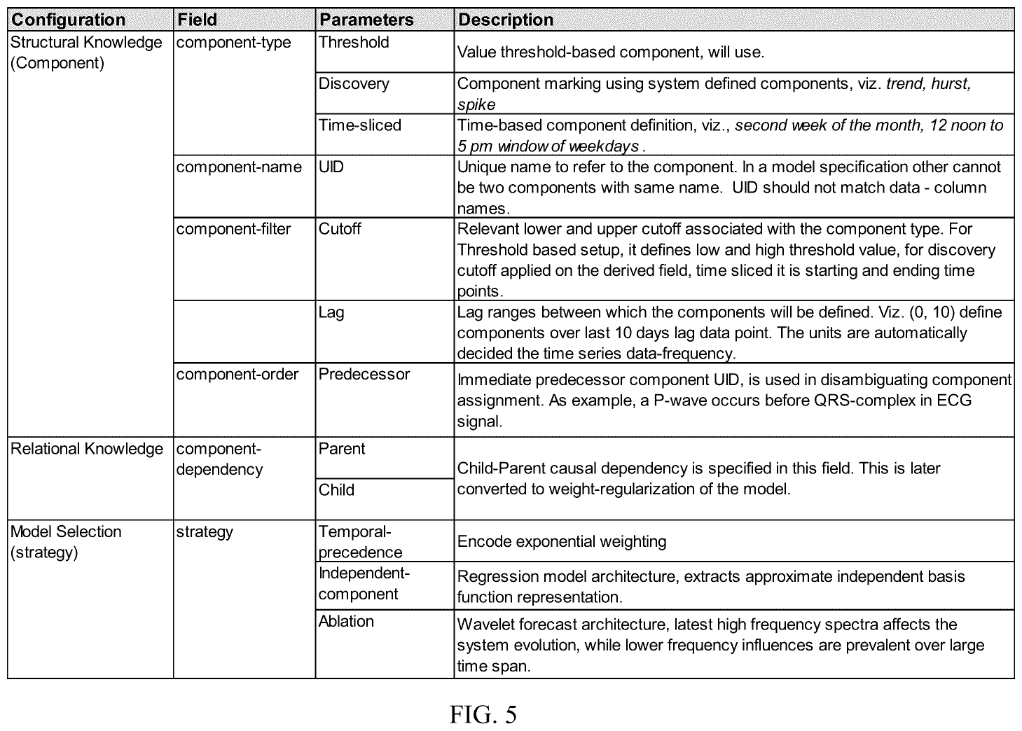

FIG. 5 illustrates an example prototype 500 of various templates that can be generated by translator 102. Illustratively, the template can include three elements that can dictate the configuration of a model representation of a time series. Illustratively, the three elements are structural knowledge, relational knowledge, and model selection, as illustrated in the first column of prototype 500. Structural knowledge corresponds to the components that comprise the model. Implementing the template as a machine-readable data structure, the data structure can include separate fields that optionally specify the type of component, component name, component filter, and component order, as illustrated in the second column of prototype 500. Each of the fields can specify one or more parameters as illustrated in column three and described in column four. Relational knowledge illustratively includes a field specifying component dependency among two or more of the model components. Component dependency indicates that there is a statistically significant likelihood that one component likely precedes or follows another. Each component that is structurally related to another component is marked by a parameter indicating whether the component is a parent (likely precedes another component) or a child (likely follows another component). Model selection also illustratively corresponds to a single field, which is designated by a strategy field illustrated in the second column of prototype 500. Three different modeling strategies (designated as strategy parameters) are illustrated in the third column of prototype 500. The modeling strategies—temporal precedence, independent component, and ablation—are merely illustrative. Various other strategies can be specified in a template generated by translator 102.

FIGS. 6A-6C illustrate three example modeling strategies. FIG. 6A illustrates example modeling strategy 600. A machine learning model constructed in accordance with modeling strategy 600 is capable of capturing temporal precedence by encoding exponential weights into the model. Often in a time series context, data points closer in time to one another affect a forecast more significantly than those farther apart in time. That is, if η(γₜ) is a numerical measure of prediction contribution, then η(γₜ) [symbol] η(γₜ₋₁) for all t [symbol] t−1. This temporal precedence is captured using exponential decay as a residual predictor. Machine learning model 114 implemented in accordance with modeling strategy 600 includes one or more component definition layers 602 that are each capable of recognizing a component specified by model template 110. The components are extracted from time series data 604 and processed through one or more hidden layers 606. Illustratively, individual components 608a, 608b, 608c, and 608d are conveyed, respectively, to functions 610a, 610b, 610c, and 610d and weighted by exponentially declining weighting functions h₁, h₂, h₃ and h₄.

FIG. 6B illustrates example modeling strategy 612. Modeling strategy 612 constructs a machine learning model having a regression model architecture that extracts approximate independent basis function representations. The model is capable of automatically discovering independent components, that is, components that are non-overlapping (minimally) segments of the time series. The structure is analogous to a maximal overlap discrete wavelet transform (MODWT). Machine learning model 114 implemented in accordance with modeling strategy 612 includes one or more component definition layers 614 that are each capable of recognizing a component specified by model template 110. The components are extracted from time series data 616 and processed through one or more hidden layers 618, generating orthogonal component extraction 620, which separates non-overlapping components (time-based segments). The individual components are processed by functions g₁, g₂, g₃ and g₄ and by independent basis functions h₁, h₂, h₃ and h₄.

FIG. 6C illustrates example modeling strategy 622. Modeling strategy 622 constructs a machine learning model having a wavelet forecasting architecture. The model is constructed such that high-frequency components of the time series affect the series' more immediate evolution (e.g., cyclicality), while lower frequency components (e.g., trend) influence the series over longer time spans. The architecture of the machine learning model is capable of generating a forecast using a forecasting sum and aggregation unit. Machine learning model 114 implemented in accordance with modeling strategy 622 includes one or more component definition layers 624 that are each capable of recognizing a component specified by model template 110. The components are extracted from time series data 626 and processed through one or more hidden layers 628. Frequency components 630a, 630b, 630c, and 630d are processed, respectively, by predictor units 632a, 632b, 632c, and 632d, the outputs of which are aggregated to generate forecast or prediction 634. Predictor units 632a, 632b, 632c, and 632d in some arrangements implement as a GAM. The GAM extends linear regression by enabling a linear model to learn non-linear relationships among variables and generating a forecast or prediction by summing individual functions of each variable. In other arrangements, predictor units 632a, 632b, 632c, and 632d perform time series forecasting using a neural basis expansion (N-BEATS). In different arrangements, modeling strategy 622 can use other types of predictor units to construct the machine learning model having a wavelet forecasting architecture. Likewise, modeling strategies 600, 612, and 622 are merely illustrative. Model template 110 in other arrangements can specify different modeling strategies.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 700 contains an example of an environment for the execution of at least some of the computer code involved in performing the inventive methods, such as deriving insights from time series data, is illustrated at block 750. The inventive methods performed with the computer code of block 750 can include implementing procedures for generating a model template from SME input characterizing a time series, generating one or more machine learning models representative of the time series, and outputting insights derived from the time series using the machine learning model(s), as described herein in the context of system 100 and methodology 200. In addition to block 750, computing environment 700 includes, for example, computer 701, wide area network (WAN) 702, end user device (EUD) 703, remote server 704, public cloud 705, and private cloud 706. In this embodiment, computer 701 includes processor set 710 (including processing circuitry 720 and cache 721), communication fabric 711, volatile memory 712, persistent storage 713 (including operating system 722 and block 750, as identified above), peripheral device set 714 (including user interface (UI), device set 723, storage 724, and Internet of Things (IoT) sensor set 725), and network module 715. Remote server 704 includes remote database 730. Public cloud 705 includes gateway 706, cloud orchestration module 741, host physical machine set 742, virtual machine set 743, and container set 744.

COMPUTER 701 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 730. As is well understood in the art of computer technology, and depending upon the technology, performance of a computer-implemented method may be distributed among multiple computers and/or between multiple locations. On the other hand, in this presentation of computing environment 700, detailed discussion is focused on a single computer, specifically computer 701, to keep the presentation as simple as possible. Computer 701 may be located in a cloud, even though it is not shown in a cloud in FIG. 7. On the other hand, computer 701 is not required to be in a cloud except to any extent as may be affirmatively indicated.

PROCESSOR SET 710 includes one, or more, computer processors of any type now known or to be developed in the future. Processing circuitry 720 may be distributed over multiple packages, for example, multiple, coordinated integrated circuit chips. Processing circuitry 720 may implement multiple processor threads and/or multiple processor cores. Cache 721 is memory that is located in the processor chip package(s) and is typically used for data or code that should be available for rapid access by the threads or cores running on processor set 710. Cache memories are typically organized into multiple levels depending upon relative proximity to the processing circuitry. Alternatively, some, or all, of the cache for the processor set may be located “off chip.” In some computing environments, processor set 710 may be designed for working with qubits and performing quantum computing.

Computer readable program instructions are typically loaded onto computer 701 to cause a series of operational steps to be performed by processor set 710 of computer 701 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 721 and the other storage media discussed below. The program instructions, and associated data, are accessed by processor set 710 to control and direct performance of the inventive methods. In computing environment 700, at least some of the instructions for performing the inventive methods may be stored in block 750 in persistent storage 713.

COMMUNICATION FABRIC 711 is the signal conduction paths that allow the various components of computer 701 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 712 is any type of volatile memory now known or to be developed in the future. Examples include dynamic type random access memory (RAM) or static type RAM. Typically, the volatile memory is characterized by random access, but this is not required unless affirmatively indicated. In computer 701, the volatile memory 712 is located in a single package and is internal to computer 701, but, alternatively or additionally, the volatile memory may be distributed over multiple packages and/or located externally with respect to computer 701.

PERSISTENT STORAGE 713 is any form of non-volatile storage for computers that is now known or to be developed in the future. The non-volatility of this storage means that the stored data is maintained regardless of whether power is being supplied to computer 701 and/or directly to persistent storage 713. Persistent storage 713 may be a read only memory (ROM), but typically at least a portion of the persistent storage allows writing of data, deletion of data and re-writing of data. Some familiar forms of persistent storage include magnetic disks and solid-state storage devices. Operating system 722 may take several forms, such as various known proprietary operating systems or open-source Portable Operating System Interface type operating systems that employ a kernel. The code included in block 750 typically includes at least some of the computer code involved in performing the inventive methods.

PERIPHERAL DEVICE SET 714 includes the set of peripheral devices of computer 701. Data communication connections between the peripheral devices and the other components of computer 701 may be implemented in various ways, such as Bluetooth connections, Near-Field Communication (NFC) connections, connections made by cables (such as universal serial bus (USB) type cables), insertion type connections (e.g., secure digital (SD) card), connections made though local area communication networks and even connections made through wide area networks such as the internet. In various embodiments, UI device set 723 may include components such as a display screen, speaker, microphone, wearable devices (such as goggles and smart watches), keyboard, mouse, printer, touchpad, game controllers, and haptic devices. Storage 724 is external storage, such as an external hard drive, or insertable storage, such as an SD card. Storage 724 may be persistent and/or volatile. In some embodiments, storage 724 may take the form of a quantum computing storage device for storing data in the form of qubits. In embodiments where computer 701 is required to have a large amount of storage (e.g., where computer 701 locally stores and manages a large database) then this storage may be provided by peripheral storage devices designed for storing very large amounts of data, such as a storage area network (SAN) that is shared by multiple, geographically distributed computers. IoT sensor set 725 is made up of sensors that can be used in Internet of Things applications. For example, one sensor may be a thermometer and another sensor may be a motion detector.

NETWORK MODULE 715 is the collection of computer software, hardware, and firmware that allows computer 701 to communicate with other computers through WAN 702. Network module 715 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 715 are performed on the same physical hardware device. In other embodiments (e.g., embodiments that utilize software-defined networking (SDN)), the control functions and the forwarding functions of network module 715 are performed on physically separate devices, such that the control functions manage several different network hardware devices. Computer readable program instructions for performing the inventive methods can typically be downloaded to computer 701 from an external computer or external storage device through a network adapter card or network interface included in network module 715.

WAN 702 is any wide area network (e.g., the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 703 is any computer system that is used and controlled by an end user (e.g., a customer of an enterprise that operates computer 701), and may take any of the forms discussed above in connection with computer 701. EUD 703 typically receives helpful and useful data from the operations of computer 701. For example, in a hypothetical case where computer 701 is designed to provide a recommendation to an end user, this recommendation would typically be communicated from network module 715 of computer 701 through WAN 702 to EUD 703. In this way, EUD 703 can display, or otherwise present, the recommendation to an end user. In some embodiments, EUD 703 may be a client device, such as thin client, heavy client, mainframe computer, desktop computer and so on.

REMOTE SERVER 704 is any computer system that serves at least some data and/or functionality to computer 701. Remote server 704 may be controlled and used by the same entity that operates computer 701. Remote server 704 represents the machine(s) that collect and store helpful and useful data for use by other computers, such as computer 701. For example, in a hypothetical case where computer 701 is designed and programmed to provide a recommendation based on historical data, then this historical data may be provided to computer 701 from remote database 730 of remote server 704.

PUBLIC CLOUD 705 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 705 is performed by the computer hardware and/or software of cloud orchestration module 741. The computing resources provided by public cloud 705 are typically implemented by virtual computing environments that run on various computers making up the computers of host physical machine set 742, which is the universe of physical computers in and/or available to public cloud 705. The virtual computing environments (VCEs) typically take the form of virtual machines from virtual machine set 743 and/or containers from container set 744. It is understood that these VCEs may be stored as images and may be transferred among and between the various physical machine hosts, either as images or after instantiation of the VCE. Cloud orchestration module 741 manages the transfer and storage of images, deploys new instantiations of VCEs and manages active instantiations of VCE deployments. Gateway 740 is the collection of computer software, hardware, and firmware that allows public cloud 705 to communicate through WAN 702.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 706 is similar to public cloud 705, except that the computing resources are only available for use by a single enterprise. While private cloud 706 is depicted as being in communication with WAN 702, in other embodiments a private cloud may be disconnected from the internet entirely and only accessible through a local/private network. A hybrid cloud is a composition of multiple clouds of different types (e.g., private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 705 and private cloud 706 are both part of a larger hybrid cloud.

The terminology used herein is for the purpose of describing particular embodiments only and is not intended to be limiting. Notwithstanding, several definitions that apply throughout this document now will be presented.

As defined herein, the singular forms “a,” “an,” and “the” include the plural forms as well, unless the context clearly indicates otherwise.

As defined herein, “another” means at least a second or more.

As defined herein, “at least one,” “one or more,” and “and/or,” are open-ended expressions that are both conjunctive and disjunctive in operation unless explicitly stated otherwise. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

As defined herein, “automatically” means without user intervention.

As defined herein, “includes,” “including,” “comprises,” and/or “comprising,” specify the presence of stated features, integers, steps, operations, elements, and/or components, but do not preclude the presence or addition of one or more other features, integers, steps, operations, elements, components, and/or groups thereof.

As defined herein, “if” means “in response to” or “responsive to,” depending upon the context. Thus, the phrase “if it is determined” may be construed to mean “in response to determining” or “responsive to determining” depending on the context. Likewise, the phrase “if [a stated condition or event] is detected” may be construed to mean “upon detecting [the stated condition or event]” or “in response to detecting [the stated condition or event]” or “responsive to detecting [the stated condition or event]” depending on the context.

As defined herein, “one embodiment,” “an embodiment,” “in one or more embodiments,” “in particular embodiments,” or similar language mean that a particular feature, structure, or characteristic described in connection with the embodiment is included in at least one embodiment described within this disclosure. Thus, appearances of the aforementioned phrases and/or similar language throughout this disclosure may, but do not necessarily, all refer to the same embodiment.

As defined herein, the phrases “in response to” and “responsive to” mean responding or reacting readily to an action or event. Thus, if a second action is performed “in response to” or “responsive to” a first action, there is a causal relationship between an occurrence of the first action and an occurrence of the second action. The phrases “in response to” and “responsive to” indicate the causal relationship.

As defined herein, “user” means a human being.

The terms first, second, etc. may be used herein to describe various elements. These elements should not be limited by these terms, as these terms are only used to distinguish one element from another unless stated otherwise or the context clearly indicates otherwise.

The inventive arrangements disclosed herein have been presented for purposes of illustration and are not intended to be exhaustive or limited to the specific ones disclosed. Many modifications and variations will be apparent to those of ordinary skill in the art without departing from the scope and spirit of the described inventive arrangements. The terminology used herein was chosen to best explain the principles of the inventive arrangements, the practical application or technical improvement over technologies found in the marketplace, or to enable others of ordinary skill in the art to understand the inventive arrangements disclosed herein.

What is claimed is:

1. A computer-implemented method, comprising:
receiving subject matter expert (SME) input via a computer-user interface of a computer, wherein the SME input characterizes one or more aspects of a time series;
generating a model template by translating the SME input using a rule-based translator implemented by the computer, wherein the model template specifies one or more components of the time series;
generating, by the computer, a machine learning model configured based on the model template, wherein the machine learning model defines a multilayer neural network having one or more component definition layers configured to extract the one or more components from time series data input corresponding to an instantiation of the time series;
determining, with respect to a decision generated by the machine learning model based on the time series data input, a component-wise contribution of each of the one or more components to the decision; and
outputting via the computer-user interface the component-wise contribution of at least one of the one or more components.

2. The computer-implemented method of claim 1, wherein the generating the model template by translating the SME input includes mapping domain-specific keywords extracted from the SME input to model-specific keywords identifying the one or more components.

3. The computer-implemented method of claim 1, wherein the model template specifies a modeling strategy and wherein the generating the machine learning model is based, at least in part, on the modeling strategy.

4. The computer-implemented method of claim 1, wherein the one or more components comprise a plurality of components, and wherein the determining a component-wise contribution for each of the plurality of components includes decomposing the time series data input to identify each of the plurality of components.

5. The computer-implemented method of claim 1, wherein the one or more components comprise a plurality of components and wherein the model template specifies a positioning of each the plurality of components relative to one another within the time series.

6. The computer-implemented method of claim 1, wherein the machine learning model is configured to generate a forecast based on the time series data input, and wherein the one or more time series insights identifies a contribution of an exogenous factor.

7. The computer-implemented method of claim 1, wherein the machine learning model is configured for anomaly detection, and wherein, in response to detecting an anomaly based on the time series data input, the one or more time series insights identifies a component as a likely cause of the anomaly.

8. The computer-implemented method of claim 1, wherein the model template comprises multiple model templates and the machine learning model comprises multiple machine learning models, each configured based on a respective one of the multiple model templates, and further comprising generating a contrastive explanation of differences between the machine learning models.

9. A system, comprising:
a processor configured to initiate operations including:
receiving subject matter expert (SME) input, wherein the SME input characterizes one or more aspects of a time series;
generating a model template by translating the SME input using a rule-based translator, wherein the model template specifies one or more components of the time series;
generating a machine learning model configured based on the model template, wherein the machine learning model defines a multilayer neural network having one or more component definition layers configured to extract the one or more components from time series data input corresponding to an instantiation of the time series;
determining, with respect to a decision generated by the machine learning model based on the time series data input, a component-wise contribution of each of the one or more components to the decision; and
outputting the component-wise contribution of at least one of the one or more components.

10. The system of claim 9, wherein the generating the model template by translating the SME input includes mapping domain-specific keywords extracted from the SME input to model-specific keywords identifying the one or more components.

11. The system of claim 9, wherein the model template specifies a modeling strategy and wherein the generating the machine learning model is based, at least in part, on the modeling strategy.

12. The system of claim 9, wherein the one or more components comprise a plurality of components, and wherein the determining a component-wise contribution for each of the plurality of components includes decomposing the time series data input to identify each of the plurality of components.

13. The system of claim 9, wherein the one or more components comprise a plurality of components and wherein the model template specifies a positioning of each the plurality of components relative to one another within the time series.

14. A computer program product, the computer program product comprising:
one or more computer-readable storage media and program instructions collectively stored on the one or more computer-readable storage media, the program instructions executable by a processor to cause the processor to initiate operations including:
receiving subject matter expert (SME) input, wherein the SME input characterizes one or more aspects of a time series;
generating a model template by translating the SME input using a rule-based translator, wherein the model template specifies one or more components of the time series;
generating a machine learning model configured based on the model template, wherein the machine learning model defines a multilayer neural network having one or more component definition layers configured to extract the one or more components from time series data input corresponding to an instantiation of the time series;
determining, with respect to a decision generated by the machine learning model based on the time series data input, a component-wise contribution of each of the one or more components to the decision; and
outputting the component-wise contribution of at least one of the one or more components.

15. The computer program product of claim 14, wherein the generating the model template by translating the SME input includes mapping domain-specific keywords extracted from the SME input to model-specific keywords identifying the one or more components.

16. The computer program product of claim 14, wherein the model template specifies a modeling strategy and wherein the generating the machine learning model is based, at least in part, on the modeling strategy.

17. The computer program product of claim 14, wherein the one or more components comprise a plurality of components, and wherein the determining a component-wise contribution for each of the plurality of components includes decomposing the time series data input to identify each of the plurality of components.

18. The computer program product of claim 14, wherein the one or more components comprise a plurality of components and wherein the model template specifies a positioning of each the plurality of components relative to one another within the time series.

19. The computer program product of claim 14, wherein the machine learning model is configured to generate a forecast based on the time series data input, and wherein the one or more time series insights identifies a contribution of an exogenous factor.

20. The computer program product of claim 14, wherein the machine learning model is configured for anomaly detection, and wherein, in response to detecting an anomaly based on the time series data input, the one or more time series insights identifies a component as a likely cause of the anomaly.
